(19) United States
(12) Patent Application Publication
(10) Pub. No.: US 2024/0403760 A1
(43) Pub. Date: Dec. 5, 2024

(54) DELIVERY SYSTEM AND DELIVERY METHOD

(71) Applicant: TOYOTA JIDOSHA KABUSHIKI KAISHA, Aichi-ken (JP)

(72) Inventors: Uori KOIKE, Saitama-shi (JP); Yuta ITOZAWA, Nagoya-shi (JP); Takashi IZUMI, Tokyo-to (JP); Tatsuya TSUBAKIMOTO, Tokyo-to (JP); Satoshi KOMAMINE, Nagoya-shi (JP)

(73) Assignee: TOYOTA JIDOSHA KABUSHIKI KAISHA, Aichi-ken (JP)

(21) Appl. No.: 18/670,733

(22) Filed: May 22, 2024

(30) Foreign Application Priority Data
May 31, 2023 (JP) 2023-090053

(51) Int. Cl. G06Q 10/0631; G06Q 10/04; G06Q 10/083

(52) U.S. Cl. CPC G06Q 10/06314; G06Q 10/04; G06Q 10/083

(57) ABSTRACT

A delivery system according to the present disclosure includes: a delivery robot configured to deliver a package to a storage place; a prediction unit configured to predict a time during which a receiver of the package is absent; and a scheduling unit configured to set a schedule so that the delivery robot delivers the package to the storage place during the time when the receiver is absent.

### CROSS REFERENCE TO RELATED APPLICATIONS

This application is based upon and claims the benefit of priority from Japanese patent application No. 2023-090053, filed on May 31, 2023, the disclosure of which is incorporated herein in its entirety by reference.

### BACKGROUND

The present disclosure relates to a delivery system and a delivery method.

Japanese Unexamined Patent Application Publication No. 2022-61816 discloses a technology for, when a package is delivered to an end user's locker (for example, a smart post) by a vehicle such as an AGV (last-mile delivery), placing the package in the locker.

### SUMMARY

When a vehicle delivers a package, a receiver may try to open the door of a delivery locker even though the delivery locker is locked because the receiver wants to receive the package quickly. Alternatively, the receiver may try to take the package directly from a robot, which is a safety concern.

The present invention has been made in view of the aforementioned circumstances, and an object thereof is to provide a delivery system and a delivery method capable of appropriately delivering a package.

A delivery system according to the present disclosure includes: a delivery robot configured to deliver a package to a storage place; a prediction unit configured to predict a time during which a receiver of the package is absent; and a scheduling unit configured to set a schedule so that the delivery robot delivers the package to the storage place during the time when the receiver is absent.

According to the present disclosure, an object of the present invention is to provide a delivery system and a delivery method capable of appropriately delivering a package.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a schematic perspective view for explaining a delivery system according to a first embodiment;

FIG. 2 is a top view schematically showing a configuration of a facility where the delivery system is utilized;

FIG. 3 is a block diagram for explaining functions of the delivery system according to the first embodiment; and

FIG. 4 is a functional block diagram showing a configuration of a control unit.

### DESCRIPTION OF EMBODIMENTS

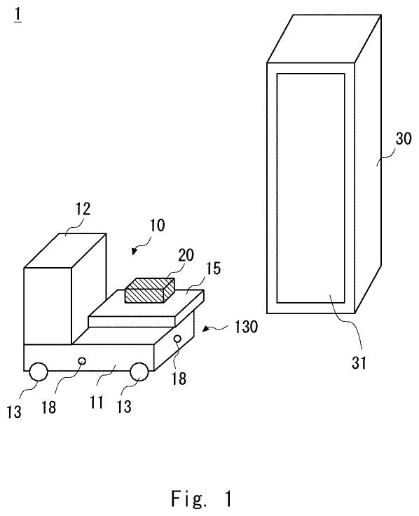

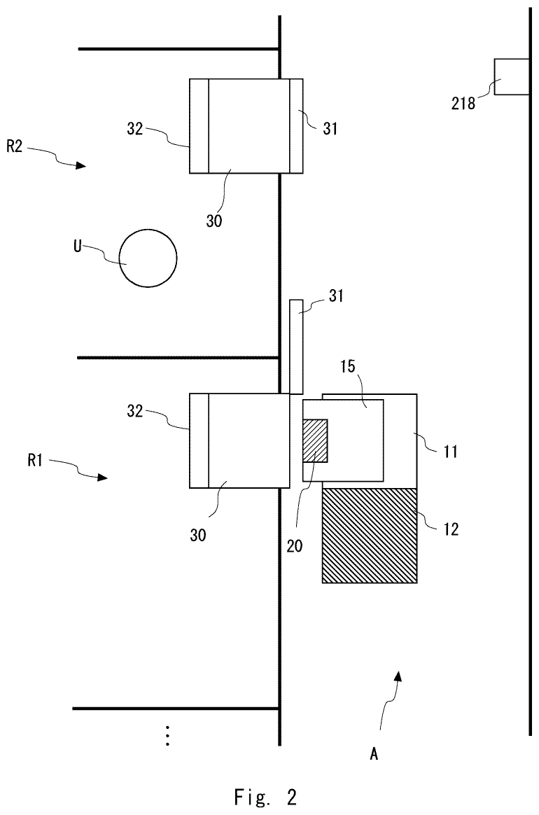

Hereinafter, a delivery system and a method therefor will be described with reference to FIGS. 1 and 2. FIG. 1 is a schematic perspective view for explaining an outline of a delivery system 1. FIG. 2 is a top view schematically showing a configuration of a facility where the delivery system 1 is utilized. The delivery system 1 is used for the last one mile in logistics, i.e., logistics services from a final base to an end user (also referred to simply as a user). For example, as shown in FIG. 2, the delivery system 1 is utilized in a facility including a plurality of rooms R1 and R2 and a passage A. Specifically, the delivery system 1 is utilized in an apartment building such as a condominium or an accommodation facility such as a hotel. The delivery system 1 may be utilized within a predetermined range of a city where a plurality of buildings exist. The buildings are not limited to apartment buildings and hotels, but may be stand-alone houses, public facilities, etc. Further, the delivery system 1 may be used in a city or a part thereof where apartment buildings, stand-alone houses, etc. are present.

The delivery system 1 includes a delivery robot 10 and a storage shelf 30. The delivery robot 10 travels through the passage A of a facility. The storage shelf 30 is installed in each house. The storage shelf 30 is installed, for example, in each of the rooms R1 and R2 of an apartment building where a user U lives. The rooms R1 and R2 are not limited to houses in the apartment building but may be hotel rooms. Alternatively, the storage shelf 30 may be installed in a stand-alone house. The storage shelf 30 serves as a storage place for storing an article 20. For example, the storage shelf 30 is a smart post or a delivery locker. The delivery robot 10 can complete delivery without having to hand an article to an end user. For example, when a user purchases the article 20 through Internet mail order or the like, the delivery robot 10 delivers the article 20 to the user (purchaser) who is a receiver. Although only two rooms R1 and R2 are shown in FIG. 1, each of the number of rooms and the number of storage shelves 30 provided in the facility may be three or more.

The delivery robot 10 moves to a plurality of storage shelves 30, stops in front of each of the storage shelves 30, and stores the article 20 in each of the storage shelves 30. This operation can also be referred to as delivery. Further, the delivery robot 10 moves to a plurality of storage shelves 30, stops in front of each of the storage shelves 30, and takes the article 20 out of the storage shelf 30, and conveys the article 20 taken out. This operation can also be referred to as a pickup. The delivery robot 10 (or the storage shelf 30) includes a mechanism for delivering articles to and from the storage shelf 30. The delivery robot 10 also includes various types of sensors, and it can detect the storage shelf 30 and obstacles in the passage A, and move autonomously. A known object recognition technique can be used.

The storage shelf 30 may include a plurality of shelves (not shown) capable of housing the articles 20. The storage shelf 30 is installed, for example, on the passage A side of each of the rooms R1 and R2 of a building or an apartment building. The delivery robot 10 accesses the storage shelf 30 from the passage A side thereof to take the article 20 out of it or put the article 20 into it. A resident (a user) accesses the storage shelf 30 from the room R1 or R2 to take the article 20 out of it or put the article 20 into it.

For example, the storage shelf 30 includes two doors 31 and 32. The door 31 is provided on the passage A side, and the door 32 is provided on the rooms R1 and R2 sides. The user U opens the door 32 and takes the article 20 out of the storage shelf 30 or puts it into the storage shelf 30 from the room R1 side. The delivery robot 10 opens the door 31 and takes the article 20 out of the storage shelf 30 or puts it into the storage shelf 30 from the passage A side. Each of the doors 31 and 32 may be, for example, a horizontally openable shutter, a vertically openable shutter, a single swing door, or a double swing door.

The doors 31 and 32 may be lockable. For example, the user U or the delivery robot 10 may lock/unlock the doors 31 and 32. By doing so, for example, the article 20 can be prevented from being stolen. The delivery robot may control opening and closing of the door 31. For example, when the delivery robot 10 moves to the vicinity of the storage shelf 30, the delivery robot sends a command to the storage shelf 30 to open the door 31 of the storage shelf 30. Radio communication between the delivery robot 10 and the storage shelf 30 is enabled.

As shown in FIG. 1, the delivery robot 10 includes a base part 11 including a plurality of wheels 13 (may be collectively referred to as a carriage part 130), a storage part 12 provided on the base part 11 and in which a large number of articles 20 can be stored, and a mounting table 15 which is provided on the base part 11 and on which each of the articles 20 is mounted. The base part 11 may be a substantially rectangular elongated plate-like member. Further, one or more sensors 18 that detect or capture an image of an object or the like present in all directions of the delivery robot 10 and detect a position of an obstacle on a road, a position of a storage shelf, or the like are provided at any place in the delivery robot 10 (the base part 11 in this example). The sensor 18 may be, for example, a camera or Light Detection And Ranging (LiDAR).

Further, the delivery robot 10 may utilize data from a sensor 218 (see FIG. 2) installed in a place other than the delivery robot 10. The sensor 218 is a monitoring camera or the like installed in a facility. Alternatively, when more than one robot is utilized in a facility, the sensor 218 may be installed in another robot. The delivery robot 10 receives data from the sensor 218 through a wireless network.

The mounting table 15 includes a mechanism for mounting one article 20 taken out of the storage part 12 and storing this article 20 on one desired shelf of the storage shelf 30. Further, the mounting table 15 can be moved up and down along a vertical direction, and includes an extendable arm (not shown) which can be extended and contracted on a horizontal direction axis. The extendable arm is configured so as to be movable in the front-rear and right-left directions. In some embodiments, the mounting table 15 may be configured so as to be rotatable about a vertical axis. The mounting table 15 may also be configured so as to be movable in all directions (360°) in a state in which the article 20 is mounted thereon. However, as shown in FIG. 1, since the storage part 12 is disposed on one side of the base part 11, the mounting table 15 cannot be moved in a certain direction of the storage part 12 (also referred to as a rear side in this specification).

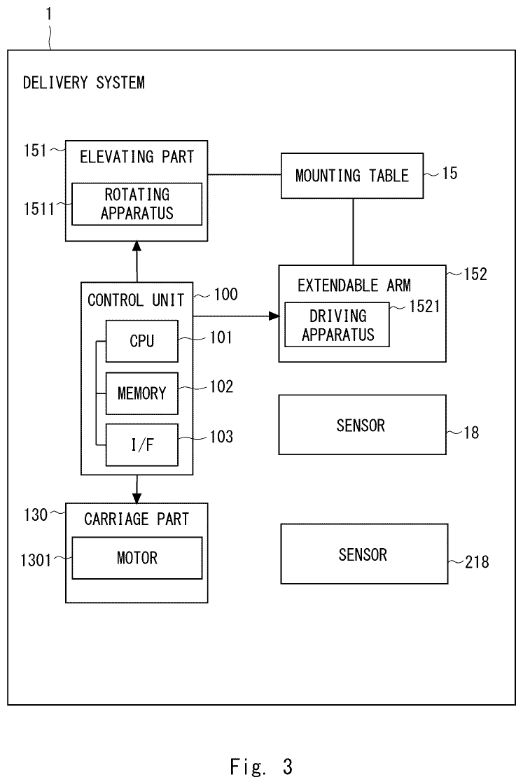

Note that the delivery system 1 may include a management server (not shown) that controls the travelling of the delivery robot 10. In this case, the management server includes a control unit 100 (see FIG. 3) connected to the delivery robot 10 through a network. In another embodiment, the control unit of the management server and the control unit of the delivery robot can achieve the present disclosure by distributing the functions thereof.

FIG. 3 is a block diagram for explaining functions of the delivery system 1. The delivery system 1 includes the control unit 100. The control unit 100 may be provided in the delivery robot 10 or a management server. The control unit 100 receives sensor signals from the sensors 18 and 218 connected thereto through a wired or wireless network and controls a normal operation of the delivery system that includes the delivery robot including the carriage part 130, an elevating part 151, an extendable arm 152, and the like. In some embodiments, the control unit 100 can control a door on the front surface of the storage shelf and an operation of a manipulator provided inside the door.

The carriage part 130 includes the base part 11, the driving wheels 13 (see FIG. 1) rotatably provided in the base part 11, and motors 1301 that rotatably drive the respective driving wheels 13. Each of the motors 1301 rotates a respective one of the driving wheels 13 through a speed reducer or the like. Each of the motors 1301 rotates a respective one of the driving wheels 13 in accordance with a control signal sent from the control unit 100. Each of the motors 1301 rotates a respective one of the driving wheels 13 in accordance with a control signal sent from the control unit 100, thereby enabling the base part 11 to move to any position. Note that the above-described configuration of the carriage part 130 is merely an example, and the configuration of the carriage part 130 is not limited to this example. For example, the number of driving wheels of the carriage part 130 and the number of driven wheels of the carriage part 130 may be any number, and any configuration in which the base part 11 can be moved to any position can be used.

The mounting table 15 moves up and down by the elevating part 151 extending and contracting along the vertical axis. The elevating part 151 includes a rotating apparatus 1511. The extendable arm 152 is attached to the mounting table 15. The extendable arm 152 includes an arm body and a driving apparatus 1521. The driving apparatus 1521, which is attached to an internal part (not shown) of the mounting table 15, moves the arm body in the horizontal direction. The driving apparatus 1521 may further include a mechanism that rotates the arm body around the axis.

The sensor 18 is provided at any place in the delivery robot 10 including the carriage part 130 and the like. The sensor 18 is also referred to as a detection unit, and is, for example, a camera and can acquire captured images. The sensor 18 can detect the presence of passages, obstacles, people, storage shelves, and the like. The sensor 18 may include a movement detection sensor that detects movement of the carriage part 130 and a height detection sensor that detects a height of the mounting table 15. In some embodiments, the sensor 18 may be attached to another traveling robot instead of a delivery robot, or may be fixed to a building or the like. In this case, like in the above case, the sensor 18 may be connected to the control unit 100 of the delivery robot 10 through a wireless network.

The control unit 100 controls a normal operation of the delivery system that includes the delivery robot including the carriage part 130, the elevating part 151, the extendable arm 152, and the like. The control unit 100 can control the rotation of each of the driving wheels 13 and move the base part 11 to any position by transmitting a control signal to each of the motors 1301 of the carriage part 130. The control unit 100 can change a height position of the mounting table 15 by transmitting a control signal to the rotating apparatus 1511 of the elevating part 151. The control unit 100 can also change a horizontal position of the arm body by transmitting a control signal to the driving apparatus 1521 of the extendable arm 152.

The control unit 100 may control the movement of the base part 11 by performing well-known control such as feedback control and robust control based on information about the rotations of the driving wheels 13 detected by a rotation sensor(s) provided in the driving wheels 13. The control unit 100 may control the operations of the carriage part 130, the elevating part 151, and the extendable arm 152 based on information such as information about a distance(s) detected by a distance sensor such as a camera or an ultrasonic sensor provided in the base part 11 and information about a map of the moving environment. The control unit 100 determines, based on the position of an obstacle detected by the camera and the position of a storage shelf, a stop position of the delivery robot relative to the storage shelf and a direction relative to the storage shelf which the delivery robot is facing when it stops.

The control unit 100 includes, for example, a microcomputer including a control program executed by a Central Processing Unit (CPU) 101 that performs control processing, arithmetic processing, etc., a memory 102 including a Read Only Memory (ROM) that stores arithmetic programs etc., and an interface unit (I/F) 103 that inputs and outputs signals to and from the outside. The CPU 101, the memory 102, and the interface unit 103 are connected to one another through a data bus or the like.

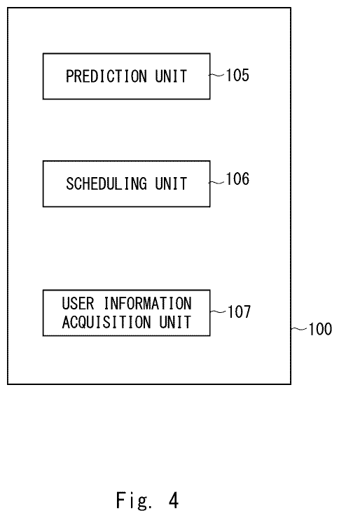

FIG. 4 is a functional block diagram showing a configuration of the control unit 100. The control unit 100 includes a prediction unit 105, a scheduling unit 106, and a user information acquisition unit 107. The prediction unit 105 predicts a time during which a receiver is absent. The prediction unit 105 predicts a time during which a user who is a receiver is not in the room. The scheduling unit 106 sets a schedule so that the article 20 is delivered to the storage shelf 30 during the time when a receiver is absent. The prediction unit 105, the scheduling unit 106, and the user information acquisition unit 107 may be mounted on the delivery robot 10 or on an external server or the like.

In this way, the article 20 can be appropriately delivered because the delivery robot 10 can deliver the article to the storage shelf 30 while a receiver is absent. For example, it is possible to prevent a user from opening the door 32 because the user wants to receive the article 20 quickly. Alternatively, it is possible to prevent a user from attempting to take the article 20 directly from the delivery robot 10 while the delivery robot 10 is transferring the package to the storage shelf 30. The delivery robot 10 can transfer the article 20 to the storage shelf 30 at a timing when a receiver is absent. Safety can be improved. It is possible to prevent an error or the like from occurring in the delivery robot 10 when a receiver comes into contact with the delivery robot 10.

The prediction unit 105 associates a room number with a user ID of a user who is a resident and stores it. The prediction unit 105 can specify a user for each room of a delivery destination. For example, when a receiver is a purchaser who has purchased the article 20 through network shopping or the like, the prediction unit 105 specifies a user who is the receiver based on purchaser information. The prediction unit 105 can specify the room number and the receiver (user ID etc.) of the delivery destination.

The control unit 100 may include the user information acquisition unit 107. The user information acquisition unit 107 acquires user information for predicting a time during which a user is absent. For example, the user information acquisition unit 107 includes a memory or the like and loads user information about a user from the memory or the like. The user information may include information about the schedule of the user.

The user information may include, for example, schedule information such as the time when the user returns home, the time during which the user is out, the working hours, and the working days. The user information acquisition unit 107 may acquire schedule information from a calendar on the network. The prediction unit 105 can predict a time during which a receiver is absent based on the schedule information. The user information may include reservation information about services such as a rental car and a restaurant. It is expected that a receiver will be absent when the receiver uses these services. The prediction unit 105 predicts a time during which a receiver is absent based on the above user information.

Alternatively, the prediction unit 105 may predict a time during which a receiver is absent using sensor data from the sensor 218. In this case, the prediction unit 105 can predict a time during which a receiver is absent without using user information. For example, it is assumed that the sensor 218 is a camera installed in the passage A or an elevator of the facility. In this case, the sensor 218 performs image processing such as face recognition on a captured image, whereby a user can be specified. The prediction unit 105 may determine that a user is absent or at home based on the sensor data. By doing so, the prediction unit 105 can determine whether a user is out or at home.

As described above, the prediction unit 105 predicts a time during which a receiver is absent. Then, the scheduling unit 106 determines a delivery schedule so that the article 20 is delivered during the time when a receiver is absent. For example, in FIG. 2, since a receiver is absent in the room R1, the delivery robot 10 transfer the article 20 to the storage shelf 30 in the room R1. On the other hand, since the user U, who is a receiver, is in the room R2, the delivery robot 10 does not deliver the article 20 to the storage shelf 30 in the room R2. In this way, article can be appropriately delivered.

Further, in a case in which a plurality of users are residents in one room, the delivery robot 10 may deliver the article 20 to the storage shelf 30 when a receiver is not present. That is, the scheduling unit 106 may set a schedule so that the article 20 is delivered when a user other than the receiver is present.

The user other than the receiver do not need to receive the article quickly. Thus, another user is less likely to directly take a package being transferred out of the delivery robot 10. Therefore, even when another user is in a room, the delivery robot 10 can appropriately deliver the article to the storage shelf 30 in the room.

Further, it is assumed that a plurality of articles 20 received by receivers different from each other are stored in the storage part 12. That is, it is assumed that delivery destinations of the articles 20 stored in the storage part 12 are different from each other. In this case, the scheduling unit 106 sets a schedule so that the plurality of articles 20 are delivered to respective rooms in order. The scheduling unit 106 determines a delivery order of the rooms so that the article 20 is delivered during the time when a receiver is absent.

For example, the scheduling unit 106 may set a schedule so that the articles 20 are delivered in an order starting from the package of the receiver whom it has been predicted will be absent. That is, the scheduling unit 106 determines a delivery order of the rooms based on the predicted time during which a receiver is absent and delivers the articles 20 in order. The scheduling unit 106 gives a lower priority to a room where a receiver is present. The delivery robot 10 gives priority to a room where a receiver is absent and then delivers an article. By doing so, it is possible to prevent the article 20 from being delivered to a room where a receiver is present, and thus an article can be appropriately delivered.

For example, as shown in FIG. 2, it is assumed that a receiver is not in the room R1 and a receiver (user U) is in the room R2 next to it. In this case, the scheduling unit 106 sets a schedule so that the delivery robot 10 delivers the articles in the order of the room R1, another room, and the room R2. The scheduling unit 106 sets a schedule so that a time when the delivery robot 10 delivers the article 20 to the room R2 is a predicted time during which the user U is absent. The delivery robot 10 may deliver the articles to a plurality of other rooms until the time when the user U is absent. The scheduling unit 106 then sets a schedule so that the delivery robot 10 moves to the room R2 after a scheduled time when the user U is out. By doing so, safety can be enhanced and an article can be appropriately delivered.

Note that the present disclosure is not limited to the above-described embodiments and may be changed as appropriate without departing from the scope and spirit of the present disclosure. Further, in the present disclosure, it is possible to implement all or part of control processing performed by the delivery system 1 by causing a Central Processing Unit (CPU) to execute a computer program. For example, the control unit 100 and the like can be implemented as an apparatus capable of executing a program, such as a Central Processing Unit (CPU) of a computer. Further, various types of functions can be implemented by the program.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A delivery system comprising:
a delivery robot configured to deliver a package to a storage place;
a prediction unit configured to predict a time during which a receiver of the package is absent; and
a scheduling unit configured to set a schedule so that the delivery robot delivers the package to the storage place during the time when the receiver is absent.

2. The delivery system according to claim 1, wherein the scheduling unit sets a schedule so that the package is delivered when another user other than the receiver is in a room corresponding to the storage place.

3. The delivery system according to claim 1, wherein
the delivery robot comprises a storage part configured so that a plurality of packages are stored therein,
the storage place is located in each of houses, and
the scheduling unit delivers the packages in an order starting from the package of the receiver whom it has been predicted will be absent.

4. The delivery system according to claim 1, wherein user information about a schedule of the receiver is acquired, and the time during which the receiver is absent is predicted based on the user information.

5. A delivery method using a delivery robot configured to deliver a package to a storage place, the delivery method comprising:
predicting a time during which a receiver of the package is absent; and
setting a schedule so that the delivery robot delivers the package to the storage place during the time when the receiver is absent.
